(19) United States
(12) Patent Application Publication
(10) Pub. No.: US 2024/0142024 A1
(43) Pub. Date: May 2, 2024

(54) HYBRID HOSE ASSEMBLY

(71) Applicant: Swagelok Company, Solon, OH (US)

(72) Inventors: Stephen J. Zaborszki, Northfield Center, OH (US); Corey Pasheilich, Solon, OH (US)

(21) Appl. No.: 18/498,371

(22) Filed: Oct. 31, 2023

Related U.S. Application Data
(60) Provisional application No. 63/420,817, filed on Oct. 31, 2022.

(51) Int. Cl. F16L 11/112; F16L 11/118

(52) U.S. Cl. CPC F16L 11/112; F16L 11/118

(57) ABSTRACT

A hose assembly includes an inner tube, a connector, a collar, and an outer metal tube. The connector includes a stem portion inserted into a distal end of the inner tube and a body portion extending radially outward and axially rearward of the stem portion. The collar is substantially coaxial with and surrounds the distal end of the inner tube, with the collar being in radial compression against the inner tube. The outer metal tube is substantially coaxial with and surrounds the inner tube and the collar, with the outer metal tube terminating at a distal end welded to the body portion of the connector.

### CROSS-REFERENCE TO RELATED APPLICATION

This application claims priority to and all benefit of U.S. Provisional Patent Application Ser. No. 63/420,817, filed on Oct. 31, 2022 and entitled HYBRID HOSE ASSEMBLY, the entire disclosure of which is incorporated by reference herein.

### TECHNICAL FIELD OF THE INVENTIONS

The present disclosure relates to flexible hose assemblies for fluid containment and transfer under a variety of pressures and temperatures between two points, and to methods of making such hose assemblies. More particularly, the disclosure relates to multi-layer or “hybrid” flexible hose assemblies having a first layer providing a first property (e.g., cleanability) and a second layer providing a second property (e.g., gas impermeability).

### SUMMARY OF THE DISCLOSURE

In accordance with an embodiment of one or more of the inventions presented in this disclosure, a hose assembly includes an inner tube, a connector, a collar, and an outer metal tube. The connector includes a stem portion inserted into a distal end of the inner tube and a body portion extending radially outward and axially rearward of the stem portion. The collar is substantially coaxial with and surrounds the distal end of the inner tube, with the collar being in radial compression against the inner tube. The outer metal tube is substantially coaxial with and surrounds the inner tube and the collar, with the outer metal tube terminating at a distal end welded to the body portion of the connector.

In accordance with another embodiment of one or more of the inventions presented in this disclosure, a method of making a hose assembly is contemplated. In an exemplary method, a distal end of an inner tube is installed over a stem portion of a connector, and a collar is installed over the distal end of the inner tube. The collar is deformed into radial compression against the distal end of the inner tube. An outer metal tube is extended over the inner tube and the collar, and a distal end of the outer metal tube is welded to a body portion of the connector extending radially outward and axially rearward of the stem portion.

In accordance with another embodiment of one or more of the inventions presented in this disclosure, a hose assembly includes an inner tube, a connector including a stem portion inserted into a distal end of the inner tube, a corrugated outer metal tube substantially coaxial with and surrounding the inner tube, with a distal endmost corrugation truncated to define a counterbore portion, and a collar substantially coaxial with and surrounding the distal end of the inner tube, the collar including a distal portion in radial compression against the inner tube and a proximal portion received in and welded to the counterbore portion of the outer metal tube.

In accordance with another embodiment of one or more of the inventions presented in this disclosure, a method of making a hose assembly is contemplated. In an exemplary method, a corrugated outer metal tube is provided, having a distal endmost corrugation truncated to define a counterbore portion. A proximal portion of a collar is received in the counterbore portion of the outer metal tube, and the proximal portion of the collar is welded to the counterbore portion of the outer metal tube. A distal end of an inner tube is inserted through the outer metal tube and the collar. A stem portion of a connector is inserted into the distal end of the inner tube. A distal portion of the collar is crimped into radial compression against the inner tube for radial compression of the inner tube against the stem portion of the connector.

In accordance with another embodiment of one or more of the inventions presented in this disclosure, a method of making a hose assembly is contemplated. In an exemplary method, a proximal portion of a collar is welded to a distal portion of an outer metal tube to form a first weld zone. A distal end of an inner tube is inserted through the outer metal tube and the collar. A stem portion of a connector is inserted into the distal end of the inner tube such that a flange portion of the connector abuts a flange portion on a distal end of the collar. The flange portion of the connector is welded to the flange portion of the collar to form a second weld zone. The collar is crimped between the first weld zone and the second weld zone and into radial compression against the inner tube for radial compression of the inner tube against the stem portion of the connector.

### BRIEF DESCRIPTION OF THE DRAWINGS

Further advantages and benefits will become apparent to those skilled in the art after considering the following description and appended claims in conjunction with the accompanying drawings, in which:

FIG. 1 is a schematic cross-sectional view of an end portion of a hose assembly, in accordance with an exemplary embodiment of the present disclosure;

FIG. 2 is a cross-sectional view of a hose assembly in accordance with another exemplary embodiment of the present disclosure, shown in a pre-assembled condition;

FIG. 3 is a cross-sectional view of the hose assembly of FIG. 2, shown with the collar compressed against the inner tube and end connector;

FIG. 3A is a cross-sectional view of a hose assembly in accordance with another exemplary embodiment of the present disclosure, shown with an end portion of the collar staked into an annular recess in the connector;

FIG. 3B is a cross-sectional view of a hose assembly in accordance with another exemplary embodiment of the present disclosure, shown with an end portion of the inner tube reinforcement layer captured between the collar and the connector flange;

FIG. 4 is a cross-sectional view of the hose assembly of FIG. 2, shown with the outer tube welded to the connector;

FIG. 5A is a cross-sectional view of a hose assembly in accordance with another exemplary embodiment of the present disclosure, shown in a pre-crimped, partially assembled condition;

FIG. 5B is a cross-sectional view of the hose assembly of FIG. 5A, shown in a crimped, fully assembled condition;

FIG. 6A is a cross-sectional view of a hose assembly in accordance with another exemplary embodiment of the present disclosure, shown in a pre-crimped, partially assembled condition; and

FIG. 6B is a cross-sectional view of the hose assembly of FIG. 6A, shown in a crimped, fully assembled condition.

### DESCRIPTION OF THE EXEMPLARY EMBODIMENTS

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Many applications have requirements for flexible hose to provide a fluid connection between two points in a fluid system, with the flexibility of the hose allowing for various fluid line routing requirements, thermal expansion, misalignment, and intermittent or continuous flexing (e.g., due to system vibrations). In addition to flexibility, different hose properties may be a consideration for use in a particular fluid system, including, for example, system temperature, system pressure, chemical compatibility, resistance to contamination, and gas permeability. In some applications, a first hose material that provides a first property (e.g., resistance to contamination) suitable for the application may have a second property (e.g., gas permeability) that is inadequate for the application. According to an exemplary aspect of the present application, a multi-layer or “hybrid” flexible hose may be provided with an inner tube providing a desired first property, and an outer tube providing a desired second property. While the inner and outer tubes may be laminated or otherwise attached to each other, in some embodiments, the inner and outer tubes may be separate from each other, and even radially spaced apart from each other, for example, to facilitate assembly or function of the hose. To facilitate installation into a fluid system, hose assemblies are commonly provided with any of a variety of end connectors, including, for example, tube fittings, tube ends (e.g., for welding or installation in a tube fitting), or quick disconnect couplings, and therefore require a leak-tight connection between the inner and outer flexible hose tube components and the end connection. Accordingly, in one aspect of the present application, an arrangement is provided to join separate inner and outer tube components to an end connector.

In an exemplary hybrid hose arrangement, a collar portion has a first end welded to a distal end of an outer metal tube, a second end welded to an end connector, and an intermediate portion compressed or crimped against an inner tube to secure the inner tube to a stem portion of the end connector inserted into the distal end of the inner tube. One such hybrid hose arrangement is described in co-owned U.S. Pat. No. 11,248,724 (the “'724 Patent”), the entire disclosure of which is incorporated herein by reference.

According to an exemplary aspect of the present disclosure, a hybrid hose assembly having an inner tube and an outer metal tube may include a connector including a stem portion inserted into a distal end portion of the inner tube, and a body portion welded to a distal end of the metal outer tube. In some such embodiments, a collar may be installed around the distal end portion of the inner tube, and deformed (e.g., crimped) into radial compression against the distal end portion of the inner tube, for example, to secure the inner tube in sealing retention with the connector. Further, by welding the distal end of the metal outer tube directly to the connector body, a second weld on each hose end may be eliminated (e.g., as compared to the hybrid hose arrangement shown in the '724 Patent).

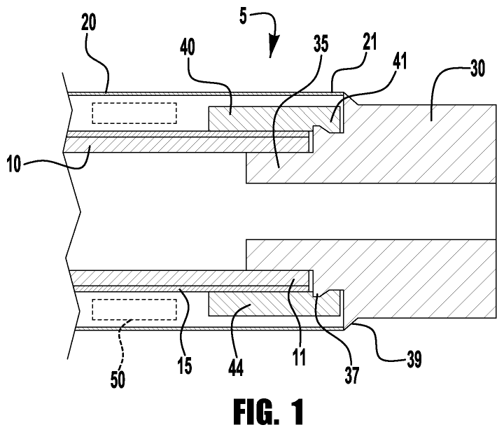

With reference to FIG. 1, a schematic cross-sectional view of an exemplary multi-tube hose 5 is presented. Note that in many of the drawings herein, the components are illustrated in longitudinal or half longitudinal cross-section, it being understood by those skilled in the art that the components are in practice annular parts about a longitudinal centerline axis X. All references herein to “radial” and “axial” are referenced to the X axis except as otherwise noted. Also, all references herein to angles are referenced to the X axis except as may be otherwise noted. Also, while the drawings disclose partial views of a hose assembly an end connector provided with an end connector at one end, it is understood by those skilled in the art that a second end connector (either identical to or different from the illustrated end connector) may be provided (e.g., by welding or by some other connection) at an opposite end of the hose assembly.

In the illustrated embodiment, the hose 5 includes an inner or core tube 10, an outer tube 20, an end connector 30 secured to distal ends 11, 21 of the inner tube and outer tube, and a collar 40 surrounded by the outer tube and in radial compression against the inner tube distal end 11 and the end connector to secure the inner tube in sealing retention with the connector. The end connector 30 may be provided with a variety of end connections for installation into a fluid system, including, for example, tube fittings, tube ends (e.g., for welding or installation in a tube fitting), quick disconnect couplings, or zero clearance face seal fittings.

The inner tube 10 and outer tube 20 may be provided in any combination of suitable materials. In an exemplary embodiment, the inner tube 10 comprises a plastic material, such as polytetrafluoroethylene (PTFE) or perfluoroalkoxy alkane (PFA), which may be selected based on fluid system compatibility, gas impermeability, flexibility, or other factors. While the inner tube may be provided in any suitable form, in one embodiment, the inner tube is provided with a smooth cylindrical internal wall, for example, for ease of cleaning and to minimize particle entrapment. The inner tube 10 may additionally include a reinforcement layer 15, such as, for example, an outer braided material (e.g., metallic or fibrous braid material) secured to the inner tube. In other embodiments (not shown), a reinforcement material (e.g., a braided material) may additionally or alternatively be secured to an interior surface of the inner tube, and/or embedded in the wall thickness of the inner tube. This reinforcement layer may provide many benefits, including, for example, prevention of kinking of the inner tube (particularly when subjected to a tighter bending radius), maintaining a smooth inside diameter as desired for fluid flow, and minimized radial and axial expansion. In an exemplary embodiment described herein, minimization of radial expansion may improve grip on the inner tube end by the connector stem (as described below), allowing the hose to withstand greater fluid pressures and axial pulling forces on the hose (e.g., due to abuse, system vibration, pulsing, or other factors).

In an exemplary embodiment, the outer tube 20 comprises a metal material, such as stainless steel, Hastelloy C-22, or Monel, which may be selected based on gas impermeability, external corrosion resistance, flexibility, weldability, or other factors. The outer tube 20 may be sized to provide a radial gap between the inner tube 10 and the outer tube 20, for example, to provide clearance and ease of insertion of the inner tube into the outer tube during assembly. While the radial gap may be minimized to minimize the outer diameter of the hose assembly (e.g., for efficient storage and routing), in other embodiments, a larger radial gap may be provided between the tubes to allow for the inclusion of radiant barrier material, insulation material, sensors (e.g., thermocouples, strain gauges), and/or other such materials or components (represented schematically at 50 in FIG. 1).

Many different types of attachment may be made between the end connector 30 and the inner tube 10. In the illustrated embodiment, the distal end 11 of the inner tube 10 is compressed against a retaining portion or stem portion 35 of the connector 30, for example, by crimping or other such compressive deformation of the collar 40 against the inner tube distal end 11. In still other embodiments (not shown), the end connector stem portion may additionally or alternatively be flared or expanded against the inner diameter of the inner tube distal end.

In the schematically illustrated embodiment of FIG. 1, a distal end 41 of the collar 40 extends over a flange portion or stem flange 37 of the connector 30, extending radially outward and axially rearward of the stem portion 35. An intermediate portion 44 of the collar 40 is compressed or crimped radially inward against the outer surface of the inner tube 10 (e.g., against the reinforcement layer 15) to compress the distal end 11 of the inner tube 10 into secure gripping engagement with the stem portion 35. Likewise, the distal end portion 41 of the collar 40 is compressed or crimped radially inward against the stem flange 37 for staked, interlocking engagement of the collar with the connector 30.

Where the outer tube is utilized to provide a leak-tight, gas-impermeable shell or sheath around a gas permeable inner tube, gas impermeable connections between the outer tube and the end connector may be provided. While many different types of attachments may be made between the outer tube 20 and the end connector 30, in one embodiment, a weld connection is provided between the outer tube and a body portion 33 of the connector to provide a leak-tight, gas impermeable connection between the outer tube and the end connector. To provide for a welded connection, the outer tube 20 and end connector 30 may be provided in suitable materials, such as, for example, stainless steel, Hastelloy C-22, or Monel, which may be selected based on external corrosion resistance, or other factors. As used herein the term “welding” is to be accorded its broadest interpretation and encompasses various types of welding as well as the concepts of brazing and soldering.

In the schematically illustrated embodiment of FIG. 1, the connector includes a second flange portion or body flange 39 extending radially outward and axially rearward of the stem flange 37. The body flange 39 is positioned to abut with the outer tube distal end 21, such that the outer tube distal end may be welded (e.g., butt weld, orbital weld) to the body flange.

The welded metal arrangement of the outer tube 20 and end connector 30 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 10 (e.g., having a gas permeability of greater than about 1×10⁻⁴ scc/sec, or between about 1×10⁻³ scc/sec and about 1×10⁻² scc/sec).

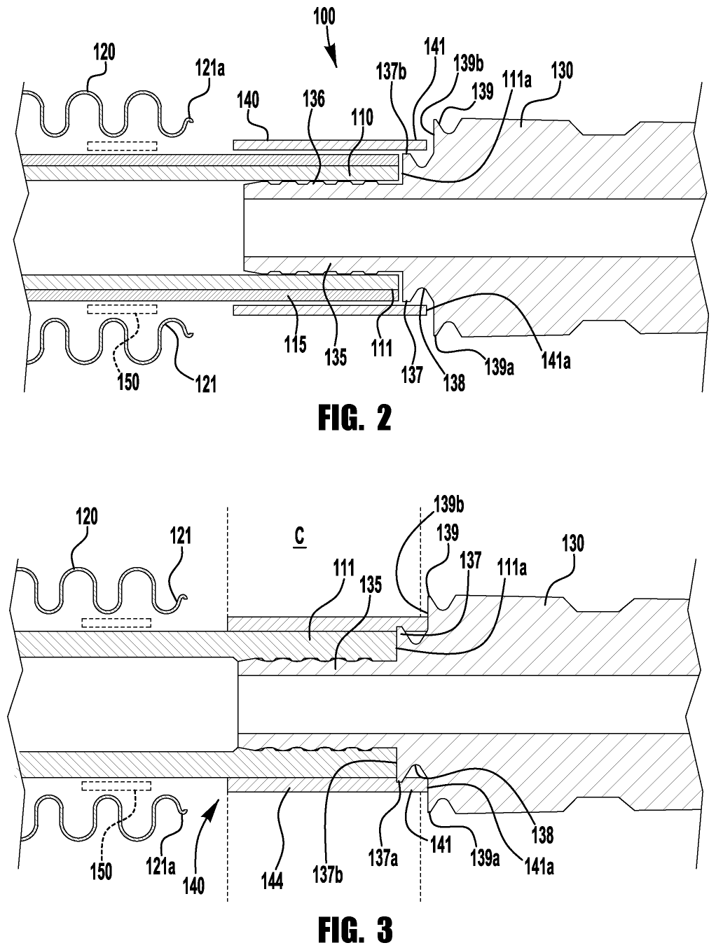

FIGS. 2, 3, and 4 illustrate exemplary embodiments of a hose 100 including an inner or core tube 110, an outer tube 120, an end connector 130 secured to distal ends 111, 121 of the inner tube and outer tube, and a collar 140 surrounded by the outer tube and in radial compression against the inner tube distal end 111 and the end connector to secure the inner tube in sealing retention with the connector.

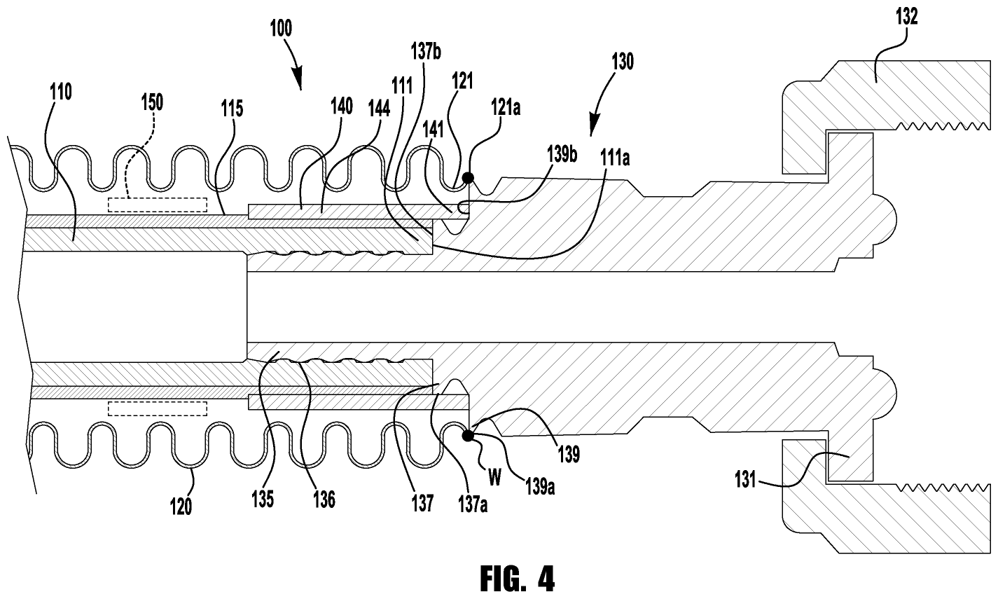

The end connector 130 may be provided with a variety of end connections for installation into a fluid system, including, for example, tube fittings, tube ends (e.g., for welding or installation in a tube fitting), quick disconnect couplings, or zero clearance face seal fittings. As shown in FIG. 4, the connector 130 may include an integral or welded face seal flange 131, and may be sized to receive a face seal fitting nut 132 over the length of the connector and against the face seal flange 131, such that the nut 132 may be preassembled with the connector 130 prior to installation of the connector on the hose, without requiring additional welding (e.g., welding a gland with captured nut to the connector).

The inner tube 110 and outer tube 120 may be provided in any combination of suitable materials. In an exemplary embodiment, the inner tube 110 comprises a plastic material, such as polytetrafluoroethylene (PTFE) or perfluoroalkoxy alkane (PFA), which may be selected based on fluid system compatibility, gas impermeability, flexibility, or other factors. While the inner tube may be provided in any suitable form, in one embodiment, the inner tube is provided with a smooth cylindrical internal wall, for example, for ease of cleaning and to minimize particle entrapment. The inner tube 110 may additionally include a reinforcement layer 115, such as, for example, an outer braided material (e.g., metallic or fibrous braid material) secured to the inner tube. In other embodiments (not shown), a reinforcement material (e.g., a braided material) may additionally or alternatively be secured to an interior surface of the inner tube, and/or embedded in the wall thickness of the inner tube. This reinforcement layer may provide many benefits, including, for example, prevention of kinking of the inner tube (particularly when subjected to a tighter bending radius), maintaining a smooth inside diameter as desired for fluid flow, and minimized radial and axial expansion. In an exemplary embodiment described herein, minimization of radial expansion may improve grip on the inner tube end by the connector stem (as described below), allowing the hose to withstand greater fluid pressures and axial pulling forces on the hose (e.g., due to abuse, system vibration, pulsing, or other factors).

In an exemplary embodiment, the outer tube 120 comprises a metal material, such as stainless steel, Hastelloy C-22, or Monel, which may be selected based on gas impermeability, external corrosion resistance, flexibility, or other factors. While the outer tube may be provided in any suitable form, in the illustrated embodiment, the outer tube 120 is provided with a corrugated wall, for example, for increased flexibility. In other embodiments, the outer tube may be helical or of some other suitable construction. The outer tube 120 may be sized to provide a radial gap between the inner tube 110 and the outer tube 120, for example, to provide clearance and ease of insertion of the inner tube into the outer tube during assembly. While the radial gap may be minimized to minimize the outer diameter of the hose assembly (e.g., for efficient storage and routing), in other embodiments, a larger radial gap may be provided between the tubes to allow for the inclusion of radiant barrier material, insulation material, sensors (e.g., thermocouples, strain gauges), and/or other such materials or components (represented schematically at 150 in FIGS. 2, 3, and 4).

While many different types of attachment may be made between the end connector 130 and the inner tube 110, in the illustrated embodiment, the end connector 130 includes a stem portion 135 received in the distal end 111 of the inner tube. As shown, the stem portion 135 may include a barbed surface 136 configured to grippingly engage the interior surface of the inner tube distal end 111. In some embodiments, secure attachment of the inner tube 110 to the end connector 130 may be achieved by press fit installation of the end connector stem portion. In the illustrated embodiment, the distal end 111 of the inner tube 110 may be compressed against the stem portion 135, for example, by crimping or other such compressive deformation of the collar 140 against the inner tube distal end 111. In still other embodiments (not shown), the end connector stem portion may additionally or alternatively be flared or expanded against the inner diameter of the inner tube distal end.

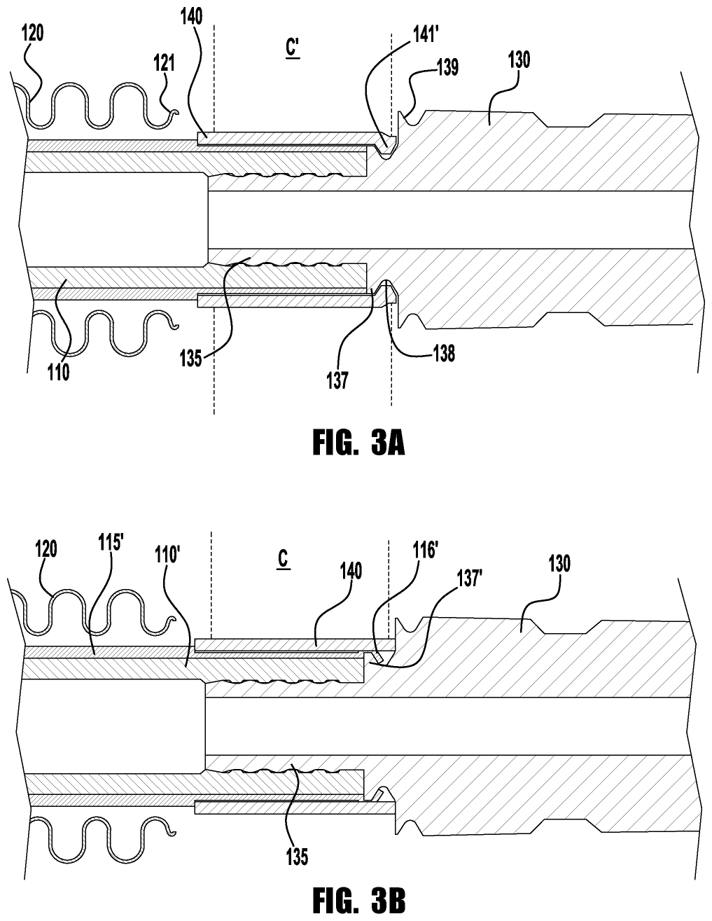

FIG. 2 illustrates the inner tube 110, outer tube 120, end connector 130, and collar 140 in a preassembled condition, with the collar in a pre-crimped condition. As shown, a distal end 141 of the collar 140 may be slipped over a flange portion or stem flange 137 of the connector 130, extending radially outward and axially rearward of the connector stem portion 135. As shown in FIG. 3, an intermediate portion 144 of the collar 140 is compressed or crimped radially inward (e.g., by crimping tool C) against the outer surface of the inner tube 110 (e.g., against the reinforcement layer 115) to compress the distal end 111 of the inner tube 110 into secure gripping engagement with the barbed stem portion 135. Likewise, the distal end portion 141 of the collar 140 is compressed or crimped radially inward against the stem flange 137 for staked, interlocking engagement of the collar with the connector 130. The collar 140 may be uniformly crimped or deformed radially inward along its length, with a biting edge 137a of the stem flange 137 embedding or indenting into the inner surface of the collar to axially secure the collar on the connector 130. In other embodiments, as shown in FIG. 3A, the distal end 141′ of the collar 140 may be crimped or deformed radially inward beyond the intermediate portion 144 (e.g., by crimping tool C′), into a recess 138 rearward of the stem flange 137, between the stem flange and a body portion 133 of the connector 130 to secure the collar against axial withdrawal.

As shown, the stem flange 137 may define a radial surface 137b positioned to align with at least a portion of the inner tube 110. In some embodiments, the inner tube 110 may be properly installed over the stem portion 135 of the connector 130 by advancing an end face 111a of the inner tube into abutment with the radial surface 137b of the flange portion 137. In other embodiments, a gauging tool (not shown) may be used (e.g., engaged with an exterior groove or step in the connector) to gauge proper installation of the inner tube over the connector stem portion.

In some embodiments, as shown in FIG. 3B, the stem flange 137′ may be sized to permit a distal end 116′ the outer reinforcement layer 115 of the inner tube 110′ to extend over the flange portion, such that when the collar distal end 141 is deformed radially inward against the stem flange 137, the reinforcement layer end (e.g., ends of the braided material) is captured between the collar distal end and the flange portion, for example, to provide a more robust attachment of the end connector and/or to increase the potential working pressure of the hose.

While the collar may be provided in a variety of structures and geometries, in the illustrated embodiment, the collar 140 is provided as a substantially tubular section, at least prior to deformation, for example, for cost efficiency, ease of manufacture, and ease of installation over the inner tube 110 and stem flange 137. The collar 140 may be provided with a substantially smooth internal bore, or with a roughened, knurled, or discontinuous (e.g., ribbed, toothed) internal surface, for example, to enhance gripping of the collar against the inner tube or flange portion.

Where the outer tube is utilized to provide a leak-tight, gas-impermeable shell or sheath around a gas permeable inner tube, gas impermeable connections between the outer tube and the end connector may be provided. While many different types of attachments may be made between the outer tube 120 and the end connector 130, in one embodiment, a weld connection is provided between the outer tube and the connector to provide a leak-tight, gas impermeable connection between the outer tube and the end connector. To provide for a welded connection, the outer tube 120 and end connector 130 may be provided in suitable materials, such as, for example, stainless steel, Hastelloy C-22, or Monel, which may be selected based on external corrosion resistance, or other factors. As used herein the term “welding” is to be accorded its broadest interpretation and encompasses various types of welding as well as the concepts of brazing and soldering.

Many different types of weld connections may be utilized. In the illustrated embodiments of FIGS. 2-4, the body portion 133 of the connector 130 includes a second flange portion or body flange 139 extending radially outward and axially rearward of the first flange portion 137. The body flange 139 is positioned to abut with the outer tube distal end 121, such that the outer tube distal end may be welded (e.g., butt welded, orbital welded) to the second flange portion (FIG. 4). In the illustrated embodiment, the second flange portion 139 defines a relatively thin annular rib 139a. The outer tube distal end 121 may be prepared (e.g., using a pipe cutter wheel) such that the truncated corrugated edge 121a of the distal end forms a lip that radially aligns with the annular rib 139a, for welding of the rib and lip portions (FIG. 4).

As shown, the second flange portion 139 may define a radial surface 139b positioned to align with at least a portion of the collar 140. In some embodiments, the collar 140 may be properly installed over the first flange portion 137 of the connector 130 by advancing an end face 141a of the collar into abutment with the radial surface 139b of the second flange portion 139. In other embodiments, a gauging tool (not shown) may be used (e.g., engaged with an exterior groove or step in the connector) to gauge proper installation of the inner tube over the connector stem portion.

The welded metal arrangement of the outer tube 120 and end connector 130 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 110 (e.g., having a gas permeability of greater than about 1×10⁻⁴ scc/sec, or between about 1×10⁻³ scc/sec and about 1×10⁻² scc/sec).

In an exemplary method of making a hose assembly, a distal end 111 of an inner tube 110 carrying a loosely assembled collar 140 and surrounding outer tube 120 is installed over a stem portion 135 of an end connector 130, with an end face 111a of the inner tube axially advanced into abutment with a radial surface 137b of the first flange portion 137 of the connector, as shown in FIG. 2. With the outer tube 120 axially spaced apart from the connector 130 (e.g., with the corrugations of the outer tube axially compressed), the collar 140 is axially advanced over the inner tube distal end 111 and over the first flange portion 137, with an end face 141a of the collar advanced into abutment with a radial surface 139b of a second flange portion 139. A crimping tool C is applied to the collar 140 to radially compress an intermediate portion 144 of the collar 140 against the inner tube 110, and a distal portion 141 of the collar 140 against the first flange portion 137 of the connector (e.g., against a biting edge 137a of the first flange portion), as shown in FIG. 3. A distal end 121 of the outer tube 120 is axially moved over the inner tube distal end 111, the collar 140, and the first flange portion 137 (e.g., by axially expanding the outer tube corrugations), and into engagement with the second flange portion 139, with a lip portion 121a of the outer tube distal end 121 radially aligning with and abutting an annular rib portion 139a of the second flange portion, and the lip portion 121a is welded to the rib portion 139a at weld bead W, as shown in FIG. 4.

According to another aspect of the present disclosure, in some applications, for example, applications involving lower pressure systems (e.g., less than about 200 psi), a hybrid hose assembly may utilize an external crimped collar having a first end welded to a distal end of the outer metal tube, and a second end crimped against the inner tube without being welded to the connector, instead relying on the length and compression of the inner tube against the inserted connector stem to provide permeation resistance at the distal end of the inner tube.

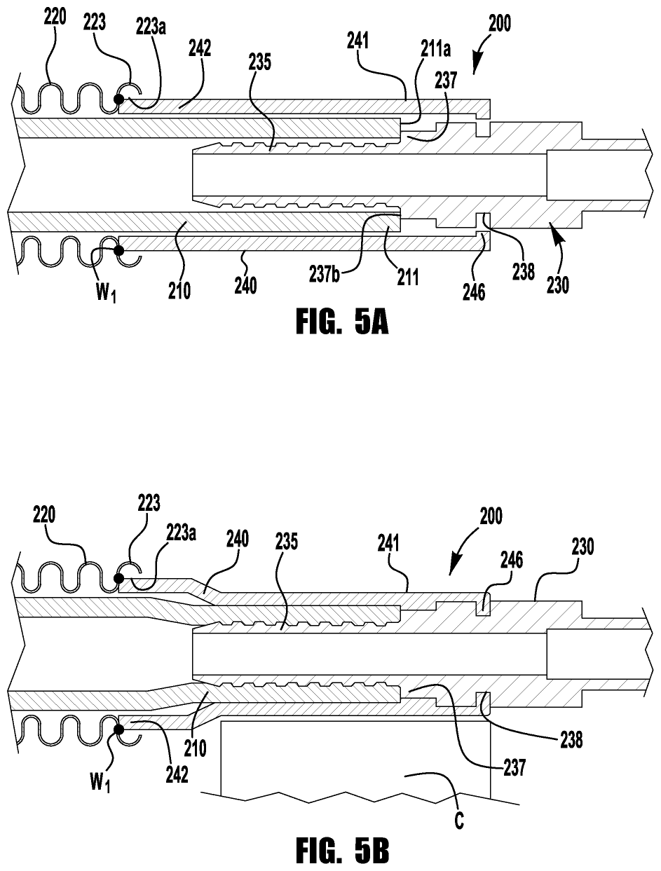

FIGS. 5A and 5B illustrate an exemplary embodiment of a hose 200 including an inner or core tube 210, an outer tube 220, an end connector 230 secured to distal ends 211, 221 of the inner tube and outer tube, and a collar 240 in radial compression against the inner tube distal end 211 and the end connector to secure the inner tube in sealing retention with the connector.

The end connector 230 may be provided with a variety of end connections for installation into a fluid system, including, for example, tube fittings, tube ends (e.g., for welding or installation in a tube fitting), quick disconnect couplings, or zero clearance face seal fittings, as shown and described herein.

The inner tube 210 and outer tube 220 may be provided in any combination of suitable materials. In an exemplary embodiment, the inner tube 210 comprises a plastic material, such as polytetrafluoroethylene (PTFE) or perfluoroalkoxy alkane (PFA), which may be selected based on fluid system compatibility, gas impermeability, flexibility, or other factors. While the inner tube may be provided in any suitable form, in one embodiment, the inner tube is provided with a smooth cylindrical internal wall, for example, for ease of cleaning and to minimize particle entrapment. The inner tube 210 may additionally include a reinforcement layer (not shown), such as, for example, a braided material (e.g., metallic or fibrous braid material) secured to the inner tube. Inclusion of a reinforcement layer on the outer surface of the inner tube may present potential leak paths between the inner tube and the collar. Accordingly, in some embodiments (not shown), a reinforcement material (e.g., a braided material) may be secured to an interior surface of the inner tube, and/or embedded in the wall thickness of the inner tube. This reinforcement layer may provide many benefits, including, for example, prevention of kinking of the inner tube (particularly when subjected to a tighter bending radius), maintaining a smooth inside diameter as desired for fluid flow, and minimized radial and axial expansion. In an exemplary embodiment described herein, minimization of radial expansion may improve grip on the inner tube end by the connector stem (as described below), allowing the hose to withstand greater fluid pressures and axial pulling forces on the hose (e.g., due to abuse, system vibration, pulsing, or other factors).

In an exemplary embodiment, the outer tube 220 comprises a metal material, such as stainless steel, Hastelloy C-22, or Monel, which may be selected based on gas impermeability, external corrosion resistance, flexibility, or other factors. While the outer tube may be provided in any suitable form, in the illustrated embodiment, the outer tube 220 is provided with a corrugated wall, for example, for increased flexibility. In other embodiments, the outer tube may be helical or of some other suitable construction. The outer tube 220 may be sized to provide a radial gap between the inner tube 210 and the outer tube 220, for example, to provide clearance and ease of insertion of the inner tube into the outer tube during assembly. While the radial gap may be minimized to minimize the outer diameter of the hose assembly (e.g., for efficient storage and routing), in other embodiments, a larger radial gap may be provided between the tubes to allow for the inclusion of radiant barrier material, insulation material, sensors (e.g., thermocouples, strain gauges), and/or other such materials or components (similar to the components 50, 150 in FIGS. 1-4).

While many different types of attachment may be made between the end connector 230 and the inner tube 210, in the illustrated embodiment, the end connector 230 includes a stem portion 235 received in the distal end 211 of the inner tube. As shown, the stem portion 235 may include a barbed surface configured to grippingly engage the interior surface of the inner tube distal end 211. In some embodiments, secure attachment of the inner tube 210 to the end connector 230 may be achieved by press fit installation of the end connector stem portion. In the illustrated embodiment, the distal end 211 of the inner tube 210 may be compressed against the stem portion 235, for example, by crimping or other such compressive deformation of the collar 240 against the inner tube distal end 211. In still other embodiments (not shown), the end connector stem portion may additionally or alternatively be flared or expanded against the inner diameter of the inner tube distal end.

FIG. 5A illustrates the inner tube 210, outer tube 220, end connector 230, and collar 240 in a preassembled condition, with the collar in a pre-crimped condition. As shown, a distal end 241 of the collar 240 may be slipped over a flange portion 237 of the connector 230, extending radially outward and axially rearward of the connector stem portion 235. As shown in FIG. 5B, a second end of the collar 240, extending distally from an intermediate portion of the collar surrounding the connector stem portion 235, is compressed or crimped radially inward (e.g., by crimping tool C) against the outer surface of the inner tube 210 to compress the distal end 211 of the inner tube 210 into secure gripping and sealing engagement with the barbed stem portion 235 and the internal surface of the collar 240. The length of the stem portion 235 may be selected to provide an elongated or extended sealing engagement with the inner tube 210, to further reduce gas permeation along the compressed portion of the inner tube. In an exemplary embodiment, a connector is utilized having a stem length to inner bore diameter ratio of at least about 5:1; for example, a connector having an inner bore diameter of about 0.14 inches and a stem length of about 0.7 inches.

In some embodiments, the distal end 241 of the collar 240 may be crimped against the connector flange portion 237, for example, to provide a limit to the degree of crimping, to provide a mechanical interlock, and/or to provide a second weld location. In the illustrated embodiment, the distal end 241 of the collar 240 includes an inner flange or dog lock 246 that aligns with and is crimped into a groove 238 in the connector 230 to provide a robust mechanical interlock between the connector and the collar.

As shown, the flange 237 may define a radial surface 237b positioned to align with at least a portion of the inner tube 210. In some embodiments, the inner tube 210 may be properly installed over the stem portion 235 of the connector 230 by advancing an end face 211a of the inner tube into abutment with the radial surface 237b of the flange portion 237. In other embodiments, a gauging tool (not shown) may be used (e.g., engaged with an exterior groove or step in the connector) to gauge proper installation of the inner tube over the connector stem portion.

While the collar may be provided in a variety of structures and geometries, in the illustrated embodiment, the collar 240 is provided as a substantially tubular section, at least prior to deformation, for example, for cost efficiency, ease of manufacture, and ease of installation over the inner tube 210 and stem flange 237. The collar 240 may be provided with a substantially smooth internal bore, or with a roughened, knurled, or discontinuous (e.g., ribbed, toothed) internal surface, for example, to enhance gripping of the collar against the inner tube or flange portion.

Where the outer tube is utilized to provide a leak-tight, gas-impermeable shell or sheath around a gas permeable inner tube, a gas impermeable connection between the outer tube and the collar may be provided. While many different types of attachments may be made between the outer tube 220 and the collar 240, in one embodiment, a weld connection is provided between the outer tube and the connector to provide a leak-tight, gas impermeable connection between the outer tube and the end connector. To provide for a welded connection, the outer tube 220 and collar 240 may be provided in suitable materials, such as, for example, stainless steel, Hastelloy C-22, or Monel, which may be selected based on external corrosion resistance, or other factors. As used herein the term “welding” is to be accorded its broadest interpretation and encompasses various types of welding as well as the concepts of brazing and soldering.

Many different types of weld connections may be utilized. In the illustrated embodiments of FIGS. 5A and 5B, a distal endmost corrugation 223 of the outer tube 220 is truncated to define a counterbore portion 223a, and a proximal end 242 of the collar 240 is received in (e.g., in abutment with) and welded to the counterbore portion of the outer metal tube (e.g., using an orbital weld).

The welded metal arrangement of the outer tube 220 and collar 240 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 210 (e.g., having a gas permeability of greater than about 1×10⁻⁴ scc/sec, or between about 1×10⁻³ scc/sec and about 1×10⁻² scc/sec). The crimped engagement of the inner tube distal end 211 with the barbed stem portion 235 may provide adequate gas impermeability (e.g., a gas permeability of less than about 1×10⁻⁵ scc/sec or between about 1×10⁻⁷ scc/sec and about 1×10⁻⁵ scc/sec), for example, in lower pressure applications (e.g., less than about 200 psi).

In an exemplary method of making a hose assembly, a corrugated outer metal tube 220 is provided, having a distal endmost corrugation 223 truncated to define a counterbore portion 223a. A proximal portion 242 of a collar 240 is received in the counterbore portion 223a of the outer metal tube 220, and the proximal portion of the collar is welded to the counterbore portion of the outer metal tube to form a weld zone W1. A distal end 211 of an inner tube 210 is inserted through the outer metal tube 220 and the collar 240, and a stem portion 235 of a connector 230 is inserted into the distal end of the inner tube. A distal portion 241 of the collar 240 is crimped into radial compression against the inner tube 210 for radial compression of the inner tube against the stem portion 235 of the connector 230.

According to another aspect of the present disclosure, in some applications, for example, applications involving higher pressure systems or requiring higher degrees of gas impermeability, a hybrid hose assembly may utilize an external crimped collar having a first end welded to a distal end of the outer metal tube, a second end welded to the connector, and an intermediate portion crimped against the inner tube.

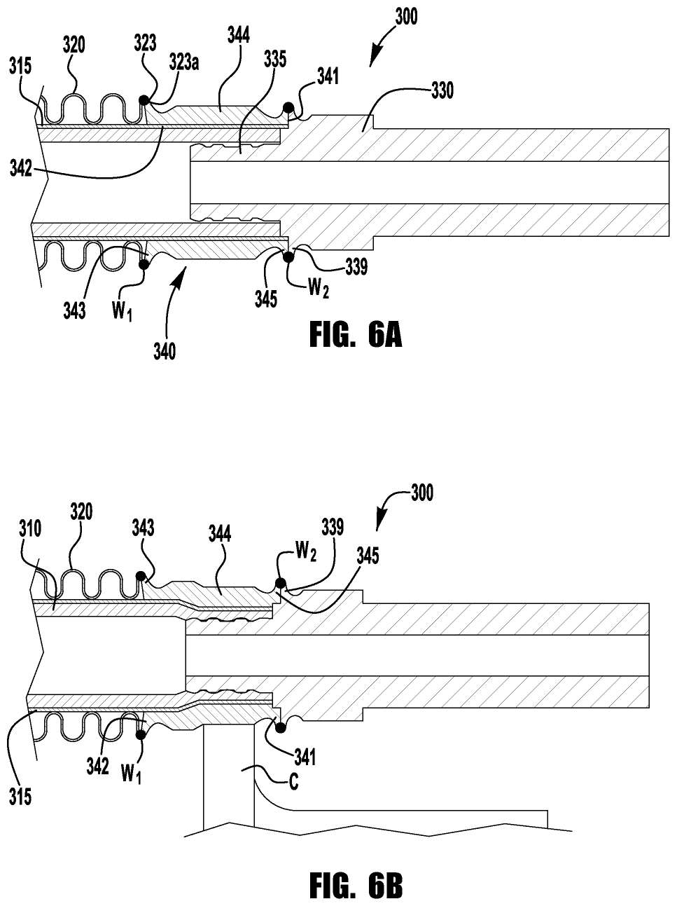

FIGS. 6A and 6B illustrate an exemplary embodiment of a hose 300 including an inner or core tube 310, an outer tube 320, an end connector 330 secured to distal ends 311, 321 of the inner tube and outer tube, and a collar 340 in radial compression against the inner tube distal end 311 and the end connector to secure the inner tube in sealing retention with the connector.

The end connector 330 may be provided with a variety of end connections for installation into a fluid system, including, for example, tube fittings, tube ends (e.g., for welding or installation in a tube fitting), quick disconnect couplings, or zero clearance face seal fittings, as shown and described herein.

The inner tube 310 and outer tube 320 may be provided in any combination of suitable materials. In an exemplary embodiment, the inner tube 310 comprises a plastic material, such as polytetrafluoroethylene (PTFE) or perfluoroalkoxy alkane (PFA), which may be selected based on fluid system compatibility, gas impermeability, flexibility, or other factors. While the inner tube may be provided in any suitable form, in one embodiment, the inner tube is provided with a smooth cylindrical internal wall, for example, for ease of cleaning and to minimize particle entrapment. The inner tube 310 may additionally include a reinforcement layer 315, such as, for example, an outer braided material (e.g., metallic or fibrous braid material) secured to the inner tube. In other embodiments (not shown), a reinforcement material (e.g., a braided material) may additionally or alternatively be secured to an interior surface of the inner tube, and/or embedded in the wall thickness of the inner tube. This reinforcement layer may provide many benefits, including, for example, prevention of kinking of the inner tube (particularly when subjected to a tighter bending radius), maintaining a smooth inside diameter as desired for fluid flow, and minimized radial and axial expansion. In an exemplary embodiment described herein, minimization of radial expansion may improve grip on the inner tube end by the connector stem (as described below), allowing the hose to withstand greater fluid pressures and axial pulling forces on the hose (e.g., due to abuse, system vibration, pulsing, or other factors).

In an exemplary embodiment, the outer tube 320 comprises a metal material, such as stainless steel, Hastelloy C-22, or Monel, which may be selected based on gas impermeability, external corrosion resistance, flexibility, or other factors. While the outer tube may be provided in any suitable form, in the illustrated embodiment, the outer tube 320 is provided with a corrugated wall, for example, for increased flexibility. In other embodiments, the outer tube may be helical or of some other suitable construction. The outer tube 320 may be sized to provide a radial gap between the inner tube 310 and the outer tube 320, for example, to provide clearance and ease of insertion of the inner tube into the outer tube during assembly. While the radial gap may be minimized to minimize the outer diameter of the hose assembly (e.g., for efficient storage and routing), in other embodiments, a larger radial gap may be provided between the tubes to allow for the inclusion of radiant barrier material, insulation material, sensors (e.g., thermocouples, strain gauges), and/or other such materials or components (represented schematically at 350 in FIGS. 6A and 6B).

While many different types of attachment may be made between the end connector 330 and the inner tube 310, in the illustrated embodiment, the end connector 330 includes a stem portion 335 received in the distal end 311 of the inner tube. As shown, the stem portion 335 may include a barbed surface configured to grippingly engage the interior surface of the inner tube distal end 311. In some embodiments, secure attachment of the inner tube 310 to the end connector 330 may be achieved by press fit installation of the end connector stem portion. In the illustrated embodiment, the distal end 311 of the inner tube 310 may be compressed against the stem portion 335, for example, by crimping or other such compressive deformation of the collar 340 against the inner tube distal end 311. In still other embodiments (not shown), the end connector stem portion may additionally or alternatively be flared or expanded against the inner diameter of the inner tube distal end.

FIG. 6A illustrates the inner tube 310, outer tube 320, end connector 330, and collar 340 in a preassembled condition, with the collar in a pre-crimped condition. As shown, a distal end 341 of the collar 340 may be brought into abutment with a body flange portion 339 of the connector 330, extending radially outward and axially rearward of the connector stem portion 335. As shown in FIG. 6B, an intermediate portion 344 of the collar 340, surrounding the connector stem portion 335, is compressed or crimped radially inward (e.g., by crimping tool C) against the outer surface of the inner tube 310 (e.g., against the reinforcement layer 315, where provided) to compress the distal end 311 of the inner tube 310 into secure gripping engagement with the barbed stem portion 335.

As shown, the stem portion may include a shoulder 337 defining a radial surface 337b positioned to align with at least a portion of the inner tube 310. In some embodiments, the inner tube 310 may be properly installed over the stem portion 335 of the connector 330 by advancing an end face 311a of the inner tube into abutment with the radial surface 337b of the shoulder 337. In other embodiments, a gauging tool (not shown) may be used (e.g., engaged with an exterior groove or step in the connector) to gauge proper installation of the inner tube over the connector stem portion.

While the collar may be provided in a variety of structures and geometries (e.g., as a substantially tubular section, similar to the collar 240 of FIGS. 5A and 5B), in the illustrated embodiment, the collar 340 is provided with endmost flange portions 343, 345, for example, for facilitating welding operations, as described in greater detail below. The collar 340 may be provided with a substantially smooth internal bore, or with a roughened, knurled, or discontinuous (e.g., ribbed, toothed) internal surface, for example, to enhance gripping of the collar against the inner tube or flange portion.

Where the outer tube is utilized to provide a leak-tight, gas-impermeable shell or sheath around a gas permeable inner tube, gas impermeable connections between the outer tube, the collar, and the connector may be provided. While many different types of attachments may be made between the outer tube 320 and the collar 340, in one embodiment, a weld connection is provided between the outer tube and the connector to provide a leak-tight, gas impermeable connection between the outer tube and the end connector. To provide for a welded connection, the outer tube 320 and collar 340 may be provided in suitable materials, such as, for example, stainless steel, Hastelloy C-22, or Monel, which may be selected based on external corrosion resistance, or other factors. As used herein the term “welding” is to be accorded its broadest interpretation and encompasses various types of welding as well as the concepts of brazing and soldering.

Many different types of weld connections may be utilized. In the illustrated embodiments of FIGS. 6A and 6B, a distal endmost corrugation 323 of the outer tube 320 is truncated to define a counterbore portion 323a, and a proximal end 342 of the collar 340 is received in (e.g., in abutment with) and welded to the counterbore portion of the outer metal tube (e.g., using an orbital weld). In the illustrated example, the distal endmost corrugation 323 is truncated at a crest of the corrugation, and the proximal collar flange 343 is sized to be closely received in the crest of the counterbore portion 323a, for example, to facilitate an autogenous weld of the proximal collar flange 343 to the counterbore portion. This same proximal collar flange and truncated corrugation counterbore welding arrangement may be utilized in other embodiments, including, for example, the embodiments of FIGS. 1-5B.

In the illustrated embodiments of FIGS. 6A and 6B, a distal end 341 of the collar 340 is engaged with (e.g., in abutment with) and welded to the body flange 339 of the connector 330 (e.g., using an orbital weld or butt weld). In the illustrated example, the distal collar flange 345 is sized to abut and align with the body flange, for example, to facilitate an autogenous weld of the distal collar flange to the connector body flange.

The welded metal arrangement of the outer tube 320, collar 340, and connector 330 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 310 (e.g., having a gas permeability of greater than about 1×10⁻⁴ scc/sec, or between about 1×10⁻³ scc/sec and about 1×10⁻² scc/sec). Since the gas impermeable shell is provided by the welded outer tube, collar, and connector arrangement, leak tight sealing engagement between the connector stem 335, inner tube 310, and collar 340 may be less critical, and the length of the stem portion may be reduced (e.g., a stem length to inner bore diameter ratio between about 2:1 and about 4:1), for example, to aid in manufacturability.

In an exemplary method of making a hose assembly, a proximal portion (e.g., flange) 343 of a collar 340 is welded to a distal portion (e.g., truncated counterbore) 323a of an outer metal tube 320 to form a first weld zone W1. A distal end 311 of an inner tube 310 is inserted through the outer metal tube 320 and the collar 340. A stem portion 335 of a connector 330 is inserted into the distal end 310 of the inner tube 310 such that a body flange portion 339 of the connector abuts a flange portion 345 on a distal end of the collar 340. The flange portion 339 of the connector 330 is welded to the flange portion 345 of the collar 340 to form a second weld zone W2. The collar 340 is then crimped between the first weld zone and the second weld zone and into radial compression against the inner tube 310 for radial compression of the inner tube against the stem portion 335 of the connector 330.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A hose assembly comprising:
an inner tube;
a connector including a stem portion inserted into a distal end of the inner tube and a body portion extending radially outward and axially rearward of the stem portion;
a collar substantially coaxial with and surrounding the distal end of the inner tube, the collar being in radial compression against the inner tube; and
an outer metal tube substantially coaxial with and surrounding the inner tube and the collar, the outer metal tube terminating at a distal end welded to the body portion of the connector.

2. The hose assembly of claim 1, wherein the body portion of the connector comprises a body flange, the distal end of the outer metal tube being welded to the body flange.

3. The hose assembly of claim 2, wherein an end face of the collar abuts a radial surface of the body flange.

4. The hose assembly of claim 2, wherein the distal end of the outer metal tube includes a truncated corrugation defining a lip portion having an outer diameter that substantially matches an outer diameter of the body flange.

5. The hose assembly of claim 2, wherein the body flange defines an annular rib, wherein the distal end of the outer metal tube is welded to the annular rib.

6. The hose assembly of claim 2, wherein the connector includes a distal gland portion, the hose assembly including a fitting nut having an inner diameter larger than an outer diameter of the body flange and smaller than an outer diameter of the distal gland portion.

7. The hose assembly of claim 1, wherein the stem portion of the connector comprises a stem flange, the collar being in radial compression against the stem flange.

8. The hose assembly of claim 7, wherein an end face of the inner tube abuts a radial surface of the stem flange.

9. The hose assembly of claim 7, wherein the inner tube comprises a reinforcement layer secured to a tubular core element, and wherein a distal end portion of the reinforcement layer is radially compressed between the collar and the stem flange.

10. The hose assembly of claim 7, wherein the stem flange defines an annular rib, wherein the collar is crimped against the annular rib.

11. The hose assembly of claim 7, wherein the connector includes an annular recess disposed between the stem flange and the body portion, wherein a distal end portion of the collar is staked into the annular recess.

12. The hose assembly of claim 1, wherein the outer metal tube comprises a corrugated tube.

13. The hose assembly of claim 1, wherein the inner tube comprises plastic.

14. (canceled)

15. The hose assembly of claim 1, wherein the inner tube comprises a reinforcement layer secured to a tubular core element.

16. The hose assembly of claim 15, wherein the reinforcement layer comprises a braided material.

17. The hose assembly of claim 15, wherein the reinforcement layer is secured to an outer surface of the core element.

18. The hose assembly of claim 1, wherein the outer metal tube and the inner tube are separated by a radial gap.

19. The hose assembly of claim 18, further comprising at least one of a radiant barrier material, an insulation material, and a sensor disposed in the radial gap.

20. The hose assembly of claim 1, wherein the collar is crimped against the distal end of the inner tube.

21.-22. (canceled)

23. A method of making a hose assembly, the method comprising:
installing a distal end of an inner tube over a stem portion of a connector;
installing a collar over the distal end of the inner tube;
deforming the collar into radial compression against the distal end of the inner tube;
extending an outer metal tube over the inner tube and the collar; and
welding a distal end of the outer metal tube to a body portion of the connector extending radially outward and axially rearward of the stem portion.

24.-72. (canceled)
